(19) United States
(12) Patent Application Publication
(10) Pub. No.: US 2016/0260973 A1
(43) Pub. Date: Sep. 8, 2016

(54) SLURRY COMPOSITION FOR NEGATIVE ELECTRODES OF LITHIUM ION SECONDARY BATTERIES, NEGATIVE ELECTRODE FOR LITHIUM ION SECONDARY BATTERIES, AND LITHIUM ION SECONDARY BATTERY

(71) Applicant: ZEON CORPORATION, Chiyoda-ku, Tokyo (JP)

(72) Inventors: Kenya SONOBE, Tokyo (JP); Yusaku MATSUO, Tokyo (JP); Junichi ASANO, Tokyo (JP); Tan KAN, Tokyo (JP)

(73) Assignee: ZEON CORPORATION, Chiyoda-ku, Tokyo (JP)

(21) Appl. No.: 15/030,665

(22) PCT Filed: Oct. 23, 2014
(86) PCT No.: PCT/JP2014/078198

§ 371 Date: Apr. 20, 2016

(30) Foreign Application Priority Data
Oct. 28, 2013 (JP) 2013-223598

(51) Int. Cl. H01M 4/62; H01M 4/133; H01M 4/587; H01M 4/38; H01M 4/36; H01M 10/0585; H01M 4/131; H01M 4/525; H01M 2/16; H01M 10/0569; H01M 10/0568; H01M 10/0567; H01M 10/0525; H01M 4/66

(52) U.S. Cl. CPC H01M 4/62; H01M 10/0525; H01M 4/133; H01M 4/587; H01M 4/386; H01M 4/364; H01M 4/661; H01M 4/131; H01M 4/525; H01M 4/625; H01M 4/623; H01M 2/1653; H01M 10/0569; H01M 10/0568; H01M 10/0567; H01M 10/0585; H01M 2004/027

(57) ABSTRACT

A slurry composition for a negative electrode of a lithium ion secondary battery, the slurry composition including 100 parts by weight of an active material (A) containing 8% by weight or higher of a non-carbon negative electrode active material, 0.5 to 10 parts by weight of a water-soluble polymer (B) containing a carboxy group, 0.01 to 0.5 parts by weight of a particulate polymer (C), and water; a negative electrode for a lithium ion secondary battery including a negative electrode material layer obtained therefrom; and a lithium ion secondary battery having the same.

### FIELD

The present invention relates to a slurry composition for a negative electrode of a lithium ion secondary battery, a negative electrode for a lithium ion secondary battery, and a lithium ion secondary battery.

### BACKGROUND

Lithium ion secondary batteries are compact and lightweight, have high energy density, and can be charged and discharged repeatedly, and thus they are widely used in many applications. In recent years, modifications of battery members such as electrodes have been studied to further improve the performance of the secondary batteries. For example, non-carbon negative electrode active materials such as silicon negative electrode active materials (i.e., negative electrode active materials containing silicon) that have a high theoretical electric capacity have been studied for use as the total amount or as a part of the negative electrode active materials (see Patent Literature 1 to 3, for example).

### CITATION LIST

### Patent Literature

Patent Literature 1: Japanese Patent Application Laid-open No. 2013-016505 A

Patent Literature 2: Japanese Patent Application Laid-open No. 2011-096520 A

Patent Literature 3: Japanese Patent Application Laid-open No. 2010-108945 A

### SUMMARY

### Technical Problem

However, non-carbon negative electrode active materials show larger volume change during charging and discharging than that of the carbon active materials, and properties such as cycle property easily deteriorate.

In the production of a negative electrode for a lithium ion secondary battery, a typical procedure is to prepare a slurry composition that includes a negative electrode active material and a component that binds the negative electrode active material, apply the slurry composition onto a substrate such as a current collector, and dry the slurry composition to form a negative electrode material layer. As a result of their studies to date, the inventors have found out that, when a non-carbon negative electrode active material is used as the negative electrode active material and a particulate polymer is added to the slurry composition as a binder for forming the active material, cycle property in particular tends to deteriorate. The inventors have also found out that, when the particulate polymer is not used, the negative electrode material layer tends to become brittle, thereby causing what is called powder falling upon cutting of a negative electrode raw material to produce a negative electrode. Furthermore, the inventors have found out that, when the particulate polymer is not used, electrode resistance undesirably increases in the resulting battery.

It is thus an object of the present invention to provide a negative electrode for a lithium ion secondary battery that can increase the electric capacity, improve cycle property, and reduce resistance and the occurrence of powder falling, and to provide a slurry composition for a negative electrode of a lithium ion secondary battery that can easily form such a negative electrode.

It is another object of the present invention to provide a lithium ion secondary battery that has a large electric capacity, excellent cycle property, and low resistance, and can be easily produced with few production problems such as powder falling.

### Solution to Problem

The inventors have conducted studies to achieve the foregoing objects. The inventors have found out that when a smaller amount of particulate polymer than an ordinary amount, and a specific amount of water-soluble polymer are added to a slurry composition for a negative electrode that contains a non-carbon negative electrode active material, cycle property can be improved and resistance can be reduced, and also the occurrence of powder falling can be reduced compared to a case in which the particulate polymer is added in an ordinary amount. The inventors have further found out that this configuration can solve the aforementioned problems at the same time, and the present invention has thus been completed. That is, according to the present invention, the following (1) to (6) are provided.

(1) A slurry composition for a negative electrode of a lithium ion secondary battery, the slurry composition comprising:

100 parts by weight of an active material (A) containing 8% by weight or higher of a non-carbon negative electrode active material;

0.5 to 10 parts by weight of a water-soluble polymer (B) containing a carboxy group;

0.01 to 0.5 parts by weight of a particulate polymer (C); and

water.

(2) The slurry composition according to (1), wherein the non-carbon negative electrode active material contained in the active material (A) is a silicon active material.

(3) The slurry composition according to (1) or (2), wherein the water-soluble polymer (B) is selected from the group consisting of carboxymethyl cellulose, a polycarboxylic acid, salts thereof, and mixtures thereof.

(4) The slurry composition according to any one of (1) to (3), wherein the particulate polymer (C) includes an aliphatic conjugated diene monomer unit and an aromatic vinyl monomer unit.

(5) A negative electrode for a lithium ion secondary battery, the negative electrode comprising a negative electrode material layer obtained from the slurry composition according to any one of (1) to (4).

(6) A lithium ion secondary battery, comprising: the negative electrode for a lithium ion secondary battery according to (5); a positive electrode; an electrolytic solution; and a separator.

### Advantageous Effects of Invention

The slurry composition for a negative electrode of a lithium ion secondary battery according to the present invention can facilitate the production of a negative electrode for a lithium ion secondary battery that can increase electric capacity, improve cycle property, and reduce resistance and the occurrence of powder falling.

The negative electrode for a lithium ion secondary battery according to the present invention can facilitate the production of a battery that has a large electric capacity, excellent cycle property, and low resistance with few production problems such as powder falling.

The lithium ion secondary battery according to the present invention has a large electric capacity, excellent cycle property, and low resistance, and can easily be produced with few production problems such as powder falling.

### DESCRIPTION OF EMBODIMENTS

The present invention will be described in detail hereinbelow by way of embodiments and examples. However, the present invention is not limited to the following embodiments and examples and any modifications can be made without departing from the scope of claims and equivalents thereto.

[1. Slurry Composition for Negative Electrode of Lithium Ion Secondary Battery]

The slurry composition for a lithium ion secondary battery according to the present invention includes an active material (A), a water-soluble polymer (B), a particulate polymer (C), and water.

[1.1. Active Material (A)]

The active material (A) includes a specific amount of non-carbon negative electrode active material. The active material (A) may include a carbon active material in addition to the non-carbon negative electrode active material. In the present invention, the carbon active material is an active material that is solely formed of a carbonaceous material, a graphite material, or a mixture thereof. The non-carbon negative electrode active material is any active material other than the carbon negative electrode active materials.

[1.1.1. Non-Carbon Negative Electrode Active Material]

Examples of the non-carbon negative electrode active material may include metal negative electrode active materials.

The metal negative electrode active materials are active materials that contain metal. The metal negative electrode active materials are active materials that usually contain in their structures an element capable of being intercalated with lithium, and preferably exhibit a theoretical electric capacity per unit weight of 500 mAh/g or more when lithium is intercalated. The upper limit of the theoretical electric capacity is not particularly limited, but may be, for example, 4000 mAh/g. Examples of the metal negative electrode active materials may include lithium metal, elemental metals capable of forming lithium alloys (for example, Ag, Al, Ba, Bi, Cu, Ga, Ge, In, Ni, P, Pb, Sb, Si, Sn, Sr, Zn, and Ti), alloys thereof, and oxides, sulfides, nitrides, silicides, carbides, and phosphides thereof.

Of these metal negative electrode active materials, an active material containing silicon (silicon negative electrode active material) is preferred. Use of the silicon negative electrode active material can increase the capacity of the lithium ion secondary battery.

Examples of the silicon negative electrode active material may include silicon (Si), alloys containing silicon, SiO, SiOₓ, and a complex of a silicon-containing material and a conductive carbon formed by coating or combining the silicon-containing material with the conductive carbon. Thus, the examples of the metal active materials also include particles containing silicon and carbon in addition to the particles formed of silicon and particles formed of silicon and oxygen.

In particular, an alloy that contains silicon (silicon alloy) is preferred as it exhibits a large capacity and can achieve good cycle property.

Examples of the silicon-containing alloy may include an alloy composition including silicon, aluminum, a transition metal such as iron, and tin, and further including a rare earth element such as yttrium. Specifically, examples of the silicon-containing alloy may include a mixture of:

(A) an amorphous phase that includes silicon; and

(B) a nanocrystalline phase that includes tin and indium, and also yttrium, a lanthanide element, an actinide element, or a combination thereof. More specifically, examples of the silicon-containing alloy may include an alloy composition represented by the following general formula (3):

SiₐAl_{b}T_{c}SnⱼInₑMⱼLi_{g} (3)

where, T represents a transition metal, M represents yttrium, a lanthanide element, an actinide element, or a combination thereof, the sum of a+b+c+d+e+f is equal to one, and 0.35≦a≦0.70, 0.01≦b≦0.45, 0.05≦c≦0.25, 00.1≦d 0.15, e≦0.15, 0.02≦f≦0.15, and 0<g≦[4.4×(a+d+e)+b].

Such an alloy may be prepared by a method disclosed in, for example, Japanese Patent Application Laid-open No. 2013-065569 A, specifically, by using a meltspun method.

SiOₓ is a compound containing Si and at least one of SiO and SiO₂, where x is usually 0.01 or more and less than 2. SiO may be formed by, for example, disproportionation reaction of silicon monoxide (SiO). Specifically, SiO may be prepared by subjecting SiO to heat treatment optionally in the presence of a polymer such as polyvinyl alcohol to produce silicon and silicon dioxide. The heat treatment may be conducted in an organic gas and/or steam atmosphere at a temperature of 900° C. or higher, preferably at 1000° C. or higher, after pulverizing and mixing SiO optionally with a polymer.

Examples of the complex of a silicon-containing material and a conductive carbon may include a compound formed by subjecting a pulverized mixture of SiO, a polymer such as polyvinyl alcohol, and, optionally, a carbon material to heat treatment in, for example, an organic gas and/or steam atmosphere. Any known method may also be used such as a method for coating the surface of SiO particles using chemical vapor deposition in an organic gas, or the like, and a method for making complex particles (granulated particles) of SiO particles and graphite or artificial graphite using a mechanochemical method.

Use of such a silicon negative electrode active material, in particular, use of a silicon-containing alloy can increase the capacity of the lithium ion secondary battery. However, the silicon negative electrode active material, in particular, the silicon-containing alloy greatly expands and contracts during charging and discharging (by a factor of about five, for example). Nevertheless the negative electrode containing the slurry composition according to the present invention that includes a specific amount of water-soluble polymer (B) and the particulate polymer (C) can suppress swelling of the negative electrode due to the expansion and contraction of the negative electrode active material even though the negative electrode includes a silicon negative electrode active material, in particular, a silicon-containing alloy. Thus, degradation of cycle property due to peeling of the negative electrode material layer off the electrode plate can sufficiently be prevented.

The content of the non-carbon negative electrode active material in the active material (A) is 8% by weight or higher, and preferably 10% by weight or higher. The upper limit of the content of the non-carbon negative electrode active material in the active material (A) is not particularly limited, but may be preferably 50% by weight or lower, more preferably 40% by weight or lower, and much more preferably 30% by weight or lower. The rest of the components in the active material (A) may be a carbon active material. By setting the content of the non-carbon negative electrode active material in the active material (A) to equal to or higher than the aforementioned lower limit, a large electric capacity can be achieved. By setting the content of the non-carbon negative electrode active material in (A) to equal to or lower than the aforementioned upper limit, good cycle property can be achieved.

[1.1.2. Carbon Negative Electrode Active Material]

In the present invention, the carbon negative electrode active material is a carbonaceous material, a graphite material, or a mixture thereof. Typically, the carbon negative electrode active material is an active material capable of being intercalated (i.e., doped) with lithium and having a carbon main structure.

The carbonaceous material is a material having a low degree of graphitization (i.e., low crystallinity) and obtained by subjecting a carbon precursor to heat treatment at 2000° C. or lower for carbonization. The lower limit of the heat treatment temperature for carbonization is not particularly limited, but may be, for example, 500° C. or higher.

Examples of the carbonaceous material may include graphitizable carbon whose carbon structure easily varies depending on the heat treatment temperature, and non-graphitizable carbon having a structure close to an amorphous structure that is typified by glass carbon.

Examples of the graphitizable carbon may include a carbon material made from tar pitch obtained from petroleum or coal. Specific examples of the graphitizable carbon may include cokes, meso-carbon microbeads (MCMB), mesophase pitch carbon fibers, and pyrolytic vapor-grown carbon fibers.

Examples of the non-graphitizable carbon may include a calcined product of phenolic resin, polyacrylonitrile carbon fibers, quasi-isotropic carbon, a calcined product of furfuryl alcohol resin (PFA), and a hard carbon.

The graphite material is a material having a high crystallinity close to the crystallinity of graphite and obtained by subjecting the graphitizable carbon to heat treatment at 2000° C. or higher. The upper limit of the heat treatment temperature is not particularly limited, but may be, for example, 5000° C. or lower.

Examples of the graphite material may include natural graphite and artificial graphite.

Examples of artificial graphite may include: artificial graphite obtained by subjecting a carbon that contains graphitizable carbon to heat treatment at mainly 2800° C. or higher; graphitized MCMB obtained by subjecting MCMB to heat treatment at 2000° C. or higher; and graphitized mesophase pitch carbon fibers obtained by subjecting mesophase pitch carbon fibers to heat treatment at 2000° C. or higher.

In order to sufficiently suppress swelling of the negative electrode and sufficiently increase the capacity of the lithium ion secondary battery, use of artificial graphite as the carbon negative electrode active material is preferred.

[1.1.3. Active Material (A): Other Properties]

The negative electrode active material is preferably in a form of granular particles. When the particles have a spherical shape, a higher-density electrode can be formed in the production of the electrode.

When the negative electrode active material is in a form of particles, the volume average particle diameter thereof is appropriately selected to take balance with the electrode density and other specifications of the secondary battery. Specifically, the volume average particle diameter of the negative electrode active material is usually 0.1 μm or larger, preferably 1 μm or larger, and more preferably 3 μm or larger, and is usually 100 μm or smaller, preferably 50 μm or smaller, and more preferably 30 μm or smaller. The volume average particle diameter is a diameter corresponding to 50% cumulative volume calculated from the smallest diameter of a particle size distribution measured by a laser diffraction method.

From the viewpoint of improving output power density, the specific surface area of the negative electrode active material is usually 0.3 m²/g or larger, preferably 0.5 m²/g or larger, and more preferably 0.8 m²/g or larger, and is usually 20 m²/g or smaller, preferably 10 m²/g or smaller, and more preferably 5 m²/g or smaller. The specific surface area of the negative electrode active material may be measured by, for example, BET method.

[1.2. Water-Soluble Polymer (B)]

The water-soluble polymer (B) is a water-soluble polymer including a carboxy group. The water-soluble polymer (B) can act as a thickener in the slurry composition according to the present invention. The water-soluble polymer (B) can keep the physical properties of the negative electrode material layer containing the slurry composition according to the present invention in suitable conditions thereby improving properties such as cycle property and resistance.

As the water-soluble polymer (B) includes a carboxy group, the water-soluble polymer (B) can give the slurry composition that contains a non-carbon negative electrode active material such as a silicon negative electrode active material a good physical property by which the slurry composition can be applied uniformly without forming lumps.

The number of carboxy groups in the water-soluble polymer (B) is preferably 0.01 to 20 mmol/g, and more preferably 0.02 to 15 mmol/g. When the water-soluble polymer (B) includes the number of carboxy groups within such a range, the slurry composition can obtain a good physical property such as good application performance.

In the present invention, that a polymer is “water-soluble” means that, when a specific sample including the polymer and water is passed through a screen of 250 mesh, the solid residue on the screen that has not passed through the screen is less than 50% by weight relative to the solid content of the polymer in the sample.

The specific sample therein is a mixture obtained by adding 1 part by weight (in terms of solid content) of a polymer to 100 parts by weight of ion-exchanged water, stirring them, and adjusting the temperature and pH to satisfy at least one set of conditions among those satisfying both a temperature range of 20 to 70° C. and a pH range of 3 to 12 (NaOH solution and/or HCl solution is used for pH adjustment).

If the mixture of the polymer and water is in an emulsified state in which the mixture will separate into two phases in a static state, the polymer is defined as water-soluble as long as the mixture satisfies the aforementioned conditions.

Examples of the water-soluble polymer (B) may include natural polymers such as carboxymethyl cellulose, carboxymethyl starch, alginic acid, a polyaspartic acid, salts thereof, and mixtures thereof, and synthetic polymers such as a polycarboxylic acid, an acrylamide-acrylic acid copolymer, an acrylamide-acrylonitrile-acrylic acid copolymer, an acrylamide-acrylic acid-2-acrylamide-2-methylpropanesulfonic acid copolymer, an acrylamide-acrylic acid-methacrylic acid copolymer, an acrylic acid-acrylonitrile-acrylic acid 2-hydroxyethyl copolymer, other copolymers including an acrylic acid and a methacrylic acid, salts thereof, and mixtures thereof. The aforementioned synthetic water-soluble polymers may be a polymer having a cross-linked structure made by using crosslinking agents such as dimethacrylate compounds, divinylbenzene, and diallyl compounds. Of these polymers, carboxymethyl cellulose, a polycarboxylic acid, salts thereof, and mixtures thereof are preferred. When these substances are used as the water-soluble polymer (B), the capacity can be increased and the cycle property can be improved.

It is particularly preferable that the water-soluble polymer (B) includes carboxymethyl cellulose or a salt thereof (hereinafter this may be simply referred to as “carboxymethyl cellulose (salt)”). The water-soluble polymer (B) including carboxymethyl cellulose (salt) can give the slurry composition better workability upon application onto, for example, a current collector.

When carboxymethyl cellulose (salt) is used as the water-soluble polymer (B), the etherification degree of the carboxymethyl cellulose (salt) is preferably 0.4 or more and more preferably 0.7 or more, and is preferably 1.8 or less and more preferably 1.5 or less. By having the etherification degree in a value within such a range, the slurry composition can have good workability upon application onto, for example, a current collector, and effects such as improvement in the cycle property can be achieved in a favorable manner.

The etherification degree of carboxymethyl cellulose (salt) is the average value of the number of hydroxy group substitution by substituents such as carboxymethyl groups per one anhydrous glucose unit constituting the carboxymethyl cellulose (salt). The etherification degree of the carboxymethyl cellulose (salt) may range from larger than zero to smaller than three. The number of hydroxy groups in a carboxymethyl cellulose (salt) molecule decreases (that is, the number of the substituents increases) as the etherification degree increases, whereas the number of hydroxy groups in a carboxymethyl cellulose (salt) molecule increases (that is, the number of the substituents decreases) as the etherification degree decreases. The etherification degree (degree of substitution) may be obtained by a method disclosed in Japanese Patent Application Laid-open No. 2011-034962 A.

The viscosity of a 1% by weight aqueous solution of carboxymethyl cellulose (salt) is preferably 500 mPa·s or higher and more preferably 1000 mPa·s or higher, and is preferably 10,000 mPa·s or lower and more preferably 9000 mPa·s or lower. Use of carboxymethyl cellulose (salt) a 1% by weight aqueous solution of which has a viscosity of 500 mPa·s or higher can give the slurry composition a suitable viscosity. Thus, the slurry composition can have good workability upon application onto, for example, the current collector. Use of carboxymethyl cellulose (salt) a 1% by weight aqueous solution of which has a viscosity of 10,000 mPa·s or lower can keep the viscosity of the slurry composition at a desirable low level. Thus, the slurry composition can have good workability upon application onto, for example, the current collector, and the adhesion property of the negative electrode material layer containing the slurry composition to the current collector can be enhanced. The viscosity of a 1% by weight aqueous solution of carboxymethyl cellulose (salt) is a value measured using a B-type viscometer at 25° C. and at a rotation speed of 60 rpm.

As another preferable embodiment, the water-soluble polymer (B) may include carboxymethyl cellulose (salt) and a polycarboxylic acid or a salt thereof (hereinafter this may be simply referred to as a “polycarboxylic acid (salt)”). Use of both carboxymethyl cellulose (salt) and a polycarboxylic acid (salt) as the water-soluble polymer (B) in this manner can enhance the adhesion property of the negative electrode material layer containing the slurry composition to the current collector, and can improve mechanical properties such as strength of the negative electrode material layer containing the water-soluble polymer (B). Further, properties such as cycle property of the secondary battery that includes the negative electrode can also be improved. The polycarboxylic acid (salt) used together with carboxymethyl cellulose (salt) is preferably an alginic acid or a salt thereof (hereinafter this may be simply referred to as an “alginic acid (salt)”), or a polyacrylic acid or a salt thereof (hereinafter this may be simply referred to as a “polyacrylic acid (salt)”), and the polyacrylic acid (salt) is the more preferable of the two. That is, it is particularly preferable that the water-soluble polymer (B) includes both carboxymethyl cellulose or a salt thereof and a polyacrylic acid or a salt thereof. An alginic acid and a polyacrylic acid have low tendency to cause excessive swelling in an electrolytic solution of the secondary battery compared to a polymethacrylic acid, and use of both carboxymethyl cellulose (salt) and an alginic acid (salt) or a polyacrylic acid (salt) can sufficiently improve, for example, cycle property of the secondary battery.

With regard to a salt of a polycarboxylic acid, examples of counter ions of the polycarboxylic acid may include metal ions such as sodium ions and lithium ions. In particular, lithium ions are preferred as they can achieve a large capacity and excellent cycle property.

In the slurry composition according to the present invention, when the water-soluble polymer (B) includes carboxymethyl cellulose (salt) and a polycarboxylic acid (salt), it is preferable that the content of the polycarboxylic acid (salt) in the total amount of the carboxymethyl cellulose (salt) and the polycarboxylic acid (salt) falls within a specific range. The content of the polycarboxylic acid (salt) is preferably 15% by weight or higher, more preferably 25% by weight or higher, and particularly preferably 40% by weight or higher, and is preferably 80% by weight or lower, more preferably 75% by weight or lower, and particularly preferably 60% by weight or lower. By setting the content of the polycarboxylic acid (salt) to 15% by weight or higher, it is possible to sufficiently obtain the effect of the combined use of the carboxymethyl cellulose (salt) and the polycarboxylic acid (salt). Consequently, the negative electrode material layer containing the slurry composition can become more resistant to the electrolytic solution, and swelling of the negative electrode material layer can thereby be suppressed. By setting the content of the polycarboxylic acid (salt) to 80% by weight or lower, it is possible to prevent the negative electrode material layer containing the slurry composition from being excessively hardened, and a good binding property and a good ionic conductivity between the components of the negative electrode material layer can thereby be achieved. In addition, the amount of residual water in the electrode can be reduced, and a drying process of the electrode can thereby be facilitated.

The amount of the water-soluble polymer (B) contained with respect to 100 parts by weight of the active material (A) in the slurry composition according to the present invention ranges from 0.5 to 10 parts by weight. The amount of the water-soluble polymer (B) contained with respect to 100 parts by weight of the active material (A) is preferably 1 part by weight or more and more preferably 3 parts by weight or more, and is preferably 8 parts by weight or less and more preferably 5 parts by weight or less. By setting the amount of the water-soluble polymer (B) to a value within the aforementioned range, it is possible to give the slurry composition a suitable viscosity, whereby the slurry composition can have good workability upon application onto, for example, the current collector. By setting the amount of the water-soluble polymer (B) to 0.5 part by weight or more with respect to 100 parts by weight of the negative electrode active material, good cycle property can be achieved. By setting the amount of the water-soluble polymer (B) to 10 parts by weight or less with respect to 100 parts by weight of the negative electrode active material, resistance of the resulting electrode can be reduced.

[1.3. Particulate Polymer (C)]

The particulate polymer (C) is a water-insoluble polymer, and has a particulate shape in the slurry composition. The “particulate polymer” is a polymer dispersible in an aqueous medium such as water, and is present in a form of particles in the aqueous medium. When 0.5 g of the particulate polymer is dissolved in 100 g of water at 25° C., the insoluble content is typically 90% by weight or more.

The particulate polymer (C) can act as a binder in the slurry composition. According to the inventors' findings, when the particulate polymer (C) is added to the slurry composition that includes a non-carbon negative electrode active material such as a silicon active material, cycle property in particular tends to deteriorate. When the particulate polymer (C) is not added, the negative electrode material layer tends to be brittle, thereby causing what is called powder falling upon cutting of a negative electrode raw material to produce a negative electrode. However, when a small amount within a specific range of the particulate polymer (C) is added in combination with a specific amount of the water-soluble polymer (B), the occurrence of powder falling can be reduced compared to a case in which the particulate polymer (C) is not added. This combination can also improve cycle property and reduce resistance compared to a case in which a large amount of particulate polymer is added. The amount of the particulate polymer (C) with respect to 100 parts by weight of the active material (A) contained in the slurry composition according to the present invention ranges from 0.01 to 0.5 part by weight. The amount of the particulate polymer (C) contained with respect to 100 parts by weight of the active material (A) is preferably 0.05 part by weight or more and more preferably 0.1 part by weight or more, and is preferably 0.4 part by weight or less and more preferably 0.3 part by weight or less. By setting the amount of the particulate polymer (C) within the aforementioned range, the aforementioned effects can be achieved.

Examples of polymers constituting the particulate polymer (C) may include a particulate polymer including an aliphatic conjugated diene monomer unit and an aromatic vinyl monomer unit (hereinafter this may be simply referred to as “particulate polymer (C1)”), and an unsaturated carboxylic acid alkyl ester polymer (hereinafter this may be simply referred to as “particulate polymer (C2)”).

[1.3.1. Particulate Polymer (C1): Polymer Including Aliphatic Conjugated Diene Monomer Unit and Aromatic Vinyl Monomer Unit]

In the particulate polymer (C1), the aliphatic conjugated diene monomer unit is a unit having a structure that is obtained by polymerizing an aliphatic conjugated diene monomer, and the aromatic vinyl monomer unit is a unit having a structure that is obtained by polymerizing an aromatic vinyl monomer. Examples of the aliphatic conjugated diene monomer may include 1,3-butadiene, 2-methyl-1,3-butadiene, 2,3-dimethyl-1,3-butadiene, 2-chloro-1,3-butadiene, substituted straight-chain conjugated pentadienes, and substituted and branched-chain conjugated hexadienes. Of these monomers, 1,3-butadiene is preferred. As the aliphatic conjugated diene monomer, one type of them may be solely used, and two or more types thereof may also be used in combination at any ratio.

The content of the aliphatic conjugated diene monomer unit in the particulate polymer (C1) is preferably 20% by weight or more and more preferably 30% by weight or more, and is preferably 70% by weight or less, more preferably 60% by weight or less, and particularly preferably 55% by weight or less. When the content of the aliphatic conjugated diene monomer unit is 20% by weight or more, flexibility of the negative electrode can be increased. When the content is 70% by weight or less, the negative electrode material layer can have a good adhesion property to the current collector, and the negative electrode containing the slurry composition according to the present invention can be more resistant to the electrolytic solution.

Examples of the aromatic vinyl monomer may include styrene, α-methylstyrene, vinyltoluene, and divinylbenzene. Of these monomers, styrene is preferred. As the aromatic vinyl monomer, one type of them may be solely used, and two or more types thereof may also be used in combination at any ratio.

The content of the aromatic vinyl monomer unit in the particulate polymer (C1) is preferably 30% by weight or more and more preferably 35% by weight or more, and is preferably 79.5% by weight or less and more preferably 69% by weight or less. When the content of the aromatic vinyl monomer unit is 30% by weight or more, the negative electrode containing the slurry composition according to the present invention can be more resistant to the electrolytic solution. When the content is 79.5% by weight or less, the negative electrode material layer can have a good adhesion property to the current collector.

In particular, it is preferable that the particulate polymer (C1) includes a 1,3-butadiene unit as the aliphatic conjugated diene monomer unit, and includes a styrene unit as the aromatic vinyl monomer unit (i.e., a styrene-butadiene copolymer is preferred).

The particulate polymer (C1) may include an optional repeating unit other than the aforementioned repeating units unless the optional repeating unit significantly impairs the effects of the present invention. Examples of monomers corresponding to the aforementioned optional repeating unit may include a vinyl cyanide monomer, an unsaturated carboxylic acid alkyl ester monomer, and an unsaturated carboxylic acid amide monomer. One type of them may be solely used, and two or more types thereof may also be used in combination at any ratio.

The content of the monomers corresponding to the optional repeating units in the particulate polymer (C1) is not particularly limited, but the upper limit thereof is preferably 10% by weight or less, more preferably 8% by weight or less, and particularly preferably 5% by weight or less, and the lower limit thereof is preferably 0.5% by weight or more, more preferably 1.0% by weight or more, and particularly preferably 1.5% by weight or more.

Examples of the vinyl cyanide monomer may include acrylonitrile, methacrylonitrile, α-chloroacrylonitrile, and α-ethylacrylonitrile. Of these monomers, acrylonitrile and methacrylonitrile are preferred. One type of them may be solely used, and two or more types thereof may also be used in combination at any ratio.

Examples of the unsaturated carboxylic acid alkyl ester monomer may include methyl acrylate, methyl methacrylate, ethyl acrylate, ethyl methacrylate, butyl acrylate, dimethyl fumarate, diethyl fumarate, dimethyl maleate, diethyl maleate, dimethyl itaconate, monomethyl fumarate, monoethyl fumarate, and 2-ethylhexyl acrylate. Of these monomers, methyl methacrylate is preferred. One type of them may be solely used, and two or more types thereof may also be used in combination at any ratio.

Examples of the unsaturated carboxylic acid amide monomer may include acrylamide, methacrylamide, N-methylol acrylamide, N-methylol methacrylamide, and N,N-dimethyl acrylamide. Of these monomers, acrylamide and methacrylamide are preferred. One type of them may be solely used, and two or more types thereof may also be used in combination at any ratio.

Other examples of the optional repeating units that may be included in the particulate polymer (C1) may include units obtained by polymerizing monomers that are used in the commonly performed emulsion polymerization such as ethylene, propylene, vinyl acetate, vinyl propionate, vinyl chloride, and vinylidene chloride. One type of them may be solely used, and two or more types thereof may also be used in combination at any ratio.

The content of the monomer units other than the aliphatic conjugated diene monomer unit and the aromatic vinyl monomer unit in the particulate polymer (C1) is not particularly limited, but the upper limit thereof in total is preferably 10% by weight or less, more preferably 8% by weight or less, and particularly preferably 5% by weight or less, and the lower limit thereof in total is preferably 0.5% by weight or more, more preferably 1.0% by weight or more, and particularly preferably 1.5% by weight or more.

The particulate polymer (C1) may be produced by, for example, polymerizing a monomer composition containing the aforementioned monomers in an aqueous solvent.

The content of each monomer in the monomer composition is usually adjusted to the same value as the content of the corresponding repeating unit in a desired particulate polymer (C1).

The type of the aqueous solvent is not particularly limited as long as the particulate polymer (C1) is dispersible in the solvent in a particulate state. The aqueous solvent is usually selected from aqueous solvents having a boiling point at normal pressure of usually 80° C. or higher and preferably 100° C. or higher, and of usually 350° C. or lower and preferably 300° C. or lower.

Specifically, examples of the aqueous solvents may include water; ketones such as diacetone alcohol and γ-butyrolactone; alcohols such as ethyl alcohol, isopropyl alcohol, and normal propyl alcohol; glycol ethers such as propylene glycol monomethyl ether, methyl cellosolve, ethyl cellosolve, ethylene glycol tert-butyl ether, butyl cellosolve, 3-methoxy-3-methyl-1-butanol, ethylene glycol monopropyl ether, diethylene glycol monobutyl ether, triethylene glycol monobutyl ether, and dipropylene glycol monomethyl ether; and ethers such as 1,3-dioxolane, 1,4-dioxolane, and tetrahydrofuran. Of these solvents, water is particularly preferred from the viewpoint of being nonflammable and capability of easily giving a dispersion of the particles of the particulate polymer (C1). The aqueous solvent may be a mixed solvent of water, as the main solvent, and an aqueous solvent other than water among the aforementioned solvents as long as the particles of the particulate polymer (C1) are dispersible in the solvent.

The polymerization method is not particularly limited. For example, any method, such as a solution polymerization method, a suspension polymerization method, a bulk polymerization method, and an emulsion polymerization method, may be used. Polymerization may be performed by any method such as ionic polymerization, radical polymerization, or living radical polymerization. Of these methods, the emulsion polymerization method is particularly preferred in terms of production efficiency. The advantages of the emulsion polymerization method in terms of production efficiency are, for example, that the method can easily produce a polymer having a high molecular weight, that the method can provide the polymer in a dispersed state in water and thus no re-dispersion treatment is needed, and that the polymer can be used as it is in the production of the slurry composition according to the present invention.

The emulsion polymerization method may be performed in accordance with a conventional method.

As the agents for use in the polymerization such as an emulsifier, a dispersing agent, a polymerization initiator, and a polymerization auxiliary agent, those that are commonly used may be used, and using amount of the agents may be set to a commonly used amount. In the polymerization, seed polymerization employing seed particles may be performed. The polymerization conditions may be selected in accordance with, e.g., the polymerization methods and the types of polymerization initiators.

The aqueous dispersion of the particles of the particulate polymer (C1) obtained by the aforementioned polymerization methods may be subjected to pH adjustment to usually 5 or higher and usually 10 or lower, and preferably 9 or lower by using an aqueous basic solution. Examples of the substance contained in the aqueous basic solution may include hydroxides of alkali metals (for example, Li, Na, K, Rb, and Cs), ammonia, inorganic ammonium compounds (for example, NH₄Cl), and organic amine compounds (for example, ethanol amine and diethyl amine). Of these substances, alkali metal hydroxides are preferred for use in pH adjustment as they enhance adhesion property of the negative electrode material layer to the current collector.

[1.3.2. Particulate Polymer (C2): Unsaturated Carboxylic Acid Alkyl Ester Polymer]

The particulate polymer (C2) is a polymer including an unsaturated carboxylic acid alkyl ester monomer unit, i.e., a polymer including a structural unit that is obtained by polymerizing the unsaturated carboxylic acid alkyl ester monomer. The content of the unsaturated carboxylic acid alkyl ester monomer unit in the particulate polymer (C2) is preferably 50% by weight or more and more preferably 80% by weight or more, and is preferably 95% by weight or less and more preferably 90% by weight or less. The particulate polymer (C2) may include a monomer unit that is obtained by polymerizing an optional monomer other than the unsaturated carboxylic acid alkyl ester monomer unit. Examples of the optional monomers may include a vinyl cyanide-based monomer, an unsaturated carboxylic acid amide monomer, a (meth)acrylic acid unit, and a (meth)acrylic acid glycidyl ether unit. Examples of the unsaturated carboxylic acid alkyl ester monomer, the vinyl cyanide-based monomer, and the unsaturated carboxylic acid amide monomer may include the same monomers as those described as the optional monomer components constituting the particulate polymer (C1). The particulate polymer (C2) may be produced by polymerizing the aforementioned monomers by a polymerization method such as the emulsion polymerization method.

[1.3.3. Properties of Particulate Polymer (C)]

The particulate polymer (C) is a water-insoluble polymer and keeps its particulate shape in the slurry composition according to the present invention. When a negative electrode material layer is formed using the slurry composition according to the present invention, at least a part of the particulate shape of the particulate polymer (C) is kept therein, to thereby exhibit the property of binding the active material (A) together.

The number average particle diameter of the particulate polymer (C) in the slurry composition according to the present invention is preferably 50 nm or larger and more preferably 70 nm or larger, and is preferably 500 nm or smaller and more preferably 400 nm or smaller. When the number average particle diameter is within the aforementioned range, the resulting negative electrode can have strength and flexibility at a preferable level. The number average particle diameter may be readily measured by, for example, the transmission electron microscope method, a Coulter counter, or the laser diffraction scattering method.

The gel content of the particulate polymer (C) is preferably 50% by weight or more and more preferably 80% by weight or more, and is preferably 98% by weight or less and more preferably 95% by weight or less.

When the gel content of the particulate polymer (C) is less than 50% by weight, the cohesive force of the particulate polymer (C) may decrease and thus the adhesion property to, for example, the current collector may become insufficient. When the gel content of the particulate polymer (C) is more than 98% by weight, the particulate polymer (C) may lose toughness and become brittle, and consequently, the adhesion property may become insufficient.

In the present invention, the “gel content” of the particulate polymer (C) may be measured by a method described in Examples of the present description.

The glass transition temperature (Tg) of the particulate polymer (C) is preferably −30° C. or higher and more preferably −20° C. or higher, and is preferably 80° C. or lower and more preferably 30° C. or lower.

When the glass transition temperature of the particulate polymer (C) is −30° C. or higher, aggregation and settling of the components of the slurry composition according to the present invention can be prevented, to thereby secure stability of the slurry composition. Furthermore, this configuration can suppress swelling of the negative electrode in a preferable manner. When the glass transition temperature of the particulate polymer (C) is 80° C. or lower, the slurry composition according to the present invention can have good workability upon application onto, for example, the current collector.

In the present invention, the “glass transition temperature” of the particulate polymer (C) may be measured by using a method described in Examples in the present description.

The glass transition temperature and the gel content of the particulate polymer (C) may be appropriately adjusted by changing the preparation conditions (for example, by changing the monomers to be used or polymerization conditions).

The glass transition temperature may be adjusted by changing the types and amounts of monomers to be used. For example, use of monomers such as styrene and acrylonitrile can increase the glass transition temperature, whereas use of monomers such as butyl acrylate and butadiene can reduce the glass transition temperature.

The gel content may be adjusted by changing the polymerization temperature, the types of polymerization initiators, the types and amounts of molecular weight modifiers, and the conversion rate at the time of the termination of the reaction. For example, the gel content may be increased by reducing a chain transfer agent, and the gel content may be reduced by increasing the chain transfer agent.

[1.4. Water and Other Solvents]

The slurry composition according to the present invention includes water. Water acts as a solvent or a dispersion medium in the slurry composition. In the slurry composition according to the present invention, the water-soluble polymer (B) is dissolved in water and the particulate polymer (C) is dispersed in water.

In the slurry composition according to the present invention, a solvent other than water may be used in combination with water as the solvent. Examples of the solvents that may be used in combination with water may include: cyclic aliphatic hydrocarbon compounds such as cyclopentane and cyclohexane; aromatic hydrocarbon compounds such as toluene and xylene; ketone compounds such as ethyl methyl ketone and cyclohexanone; ester compounds such as ethyl acetate, butyl acetate, γ-butyrolactone, and ε-caprolactone; nitrile compounds such as acetonitrile and propionitrile; ether compounds such as tetrahydrofuran and ethylene glycol diethyl ether; alcohol compounds such as methanol, ethanol, isopropanol, ethylene glycol, and ethylene glycol monomethyl ether; and amide compounds such as N-methylpyrrolidone (NMP), and N,N-dimethylformamide. One type of them may be solely used, and two or more types thereof may also be used in combination at any ratio.

It is preferable that the amount of the solvent used in the slurry composition according to the present invention is set such that the solid content concentration of the slurry composition falls within a desired range. Specifically, the solid content concentration of the slurry composition is preferably 10% by weight or more, more preferably 15% by weight or more, and particularly preferably 20% by weight or more, and is preferably 80% by weight or less, more preferably 75% by weight or less, and particularly preferably 70% by weight or less. The solid content of the composition is the residual substance after drying of the composition.

[1.5. Optional Component: Cellulose Nanofibers]

The slurry composition according to the present invention may include cellulose nanofibers as an optional component in addition to the aforementioned components. Cellulose nanofibers are fibers having an average fiber diameter of less than 1 μm that are produced from cellulose fibers such as plant-derived cellulose fibers by defibrating by a method such as mechanical defibration. The average fiber diameter is preferably 100 nm or smaller, and is preferably 1 nm or larger. Specific examples of cellulose nanofibers may include products such as “CELISH (registered trademark) KY-100G” manufactured by Daicel Corporation. The slurry composition including cellulose nanofibers can realize still better achievement in cycle property improvement and resistance reduction.

When the slurry composition according to the present invention includes cellulose nanofibers, the amount of cellulose nanofibers contained in the slurry composition according to the present invention with respect to 100 parts by weight of the particulate polymer (C) is preferably 0.1 part by weight or more and more preferably 0.5 part by weight or more, and is preferably 10.0 parts by weight or less and more preferably 5.0 parts by weight or less. By setting the amount within the aforementioned range, still better cycle property improvement and resistance reduction can be achieved.

[1.6. Other Components]

The slurry composition according to the present invention may include other components such as a conductive agent, a reinforcing material, a leveling agent, and an electrolytic solution additive in addition to the aforementioned components. The types of these components are not particularly limited unless the components adversely affect battery reaction. Any known components such as those disclosed in WO 2012/115096 may be used. One type of them may be solely used, and two or more types thereof may also be used in combination at any ratio.

[1.7. Preparation of Slurry Composition]

The slurry composition according to the present invention may be prepared by, following optional preliminary mixing of a part of the components, effecting dispersion of the components in an aqueous medium as the dispersion medium. Alternatively the slurry composition may also be prepared by firstly preparing a binder composition including the water-soluble polymer (B) and the particulate polymer (C), and then effecting dispersion of the binder composition and the active material (A) in an aqueous medium as the dispersion medium. In terms of dispersibility of the components of the slurry composition, it is preferable to prepare the slurry composition by effecting dispersion of the components in an aqueous medium as the dispersion medium. Specifically, it is preferred to mix the components and the aqueous medium by using a mixer such as a ball mill, a sand mill, a bead mill, a pigment dispersing machine, a grinder, an ultrasonic dispersion machine, a homogenizer, a planetary mixer, or a FILMIX, to prepare the slurry composition. The components and the aqueous medium may be mixed at a temperature within a range of from room temperature to 80° C. for a time period within a range of from 10 minutes to several hours.

[2. Negative Electrode for Secondary Battery]

The negative electrode for a lithium ion secondary battery according to the present invention includes a negative electrode material layer obtained from the slurry composition according to the present invention. Usually, the negative electrode for a lithium ion secondary battery according to the present invention further includes a current collector. As the negative electrode for a lithium ion secondary battery according to the present invention includes the negative electrode material layer obtained from the slurry composition according to the present invention, use of the negative electrode in a battery realizes achievement of favorable effects such as improving cycle property and reducing resistance. In addition to these effects, powder falling upon processing the negative electrode to conform to the shape of the battery package can also be reduced.

The negative electrode for a secondary battery according to the present invention may be produced by the following steps: a step of applying the slurry composition according to the present invention onto a current collector (application step); a step of drying the slurry composition applied onto the current collector to form a negative electrode material layer on the current collector (drying step); and a step optionally performed to further heat the negative electrode material layer (heating step).

[2.1. Application Step]

The method for applying the slurry composition onto the current collector is not particularly limited, and any known method may be used. Specifically, examples of the application method may include a doctor blade method, a dipping method, a reverse roll method, a direct roll method, a gravure method, an extrusion method, and a brush coating method. At the application step, the slurry composition may be applied to only one surface of the current collector, and may also be applied to both surfaces thereof. The thickness of the applied slurry layer on the current collector before drying may be appropriately set in accordance with the thickness of the negative electrode material layer to be obtained after drying.

As the current collector to which the slurry composition is applied, a material having electric conductivity and electrochemical durability is used. Specifically, as the current collector, a current collector composed of a material such as iron, copper, aluminum, nickel, stainless steel, titanium, tantalum, gold, or platinum may be used. Of these materials, copper foil is particularly preferred for use in the current collector of the negative electrode. One type of them may be solely used, and two or more types thereof may also be used in combination at any ratio.

[2.2. Drying Step]

The method for drying the slurry composition on the current collector is not particularly limited, and any known method may be used. Examples of the drying method may include drying by warm air, hot air, or low-humidity air, vacuum drying, and drying by irradiating the slurry composition with infrared rays or electron beams. After drying the slurry composition on the current collector by the aforementioned methods, a negative electrode material layer is formed on the current collector, and thus a negative electrode for a secondary battery including the current collector and the negative electrode material layer can be obtained.

After the drying step, the negative electrode material layer may be subjected to pressure treatment using, for example, a metal die press or a roll press. This pressure treatment can improve adhesion property of the negative electrode material layer to the current collector.

[3. Secondary Battery]

The lithium ion secondary battery according to the present invention includes a positive electrode, a negative electrode, an electrolytic solution, and a separator. As the negative electrode, the lithium ion secondary battery according to the present invention includes the negative electrode for a lithium ion secondary battery according to the present invention. As the lithium ion secondary battery according to the present invention includes the negative electrode for a lithium ion secondary battery according to the present invention, it has excellent cycle property and low resistance. Furthermore, in the production process, the lithium ion secondary battery according to the present invention can be easily produced with reduced production problems such as powder falling during cutting of the negative electrode. The secondary battery according to the present invention may be preferably used for, for example, mobile phones such as smartphones, tablets, personal computers, electric vehicles, and stationary storage batteries for emergency use.

[3.1. Positive Electrode]

As the positive electrode of the secondary battery, any known positive electrode used as the positive electrode of a lithium ion secondary battery may be used. Specifically, for example, a positive electrode including a positive electrode material layer formed on a current collector may be used as the positive electrode.

As the current collector, a current collector composed of a metal material such as aluminum may be used. As the positive electrode material layer, a layer including a known positive electrode active material, a conductive material, and a binder may be used. As the binder, a known particulate polymer may be used.

[3.2. Electrolytic Solution]

As the electrolytic solution, an electrolytic solution obtained by dissolving an electrolyte in a solvent may be used.

As the solvent, an organic solvent that can dissolve electrolytes may be used. Specifically, as the solvent, a solvent may be used that is obtained by adding a viscosity modification solvent such as 2,5-dimethyltetrahydrofuran, tetrahydrofuran, diethyl carbonate, ethyl methyl carbonate, dimethyl carbonate, methyl acetate, dimethoxyethane, dioxolane, methyl propionate, or methyl formate to an alkyl carbonate solvent such as ethylene carbonate, propylene carbonate, or γ-butyrolactone.

As the electrolyte, a lithium salt may be used. As the lithium salt, for example, lithium salts disclosed in Japanese Patent Application Laid-open No. 2012-204303 A may be used. Of these lithium salts, LiPF₆, LiClO₄, and CF₃SO₃Li are preferred for use as the electrolyte as they have high solubility in organic solvents and exhibit a high degree of dissociation.

As the electrolytic solution, a gel electrolyte containing polymers and the aforementioned electrolytic solution, or an intrinsic polymer electrolyte may also be used.

[3.3. Separator]

As the separator, separators disclosed in, for example, Japanese Patent Application Laid-open No. 2012-204303 A may be used. Of these separators, a fine porous film that is formed of a polyolefin-based resin (polyethylene, polypropylene, polybutene, or polyvinyl chloride) is preferred as the resin can make the entire separator thinner, which enables enlargement of the content of the electrode active material in the secondary battery and enlargement of the capacity per volume. As the separator, a separator including a porous film formed by binding non-conductive particles with a known particulate polymer may also be used.

[3.4. Method for Producing Secondary Battery]

The secondary battery according to the present invention may be produced, for example, in the following manner: the positive electrode and the negative electrode are stacked with the separator interposed therebetween; the resulting stack is wound or folded as necessary to conform to the shape of the battery and then put into a battery container; and the battery container is filled with an electrolytic solution and then sealed. To prevent an increase in the pressure inside the lithium ion secondary battery, and to prevent overcharging and overdischarging, the secondary battery may be provided with an over-current protective element such as a fuse or a PTC element, expanded metal, or a lead plate as necessary. The secondary battery may be of any shape such as a coin shape, a button shape, a sheet shape, a cylindrical shape, a rectangular shape, or a flat shape.

### EXAMPLES

The present invention will be specifically described hereinbelow by way of examples. However, the present invention is not limited to these examples. In the following description, “%” and “part” used to represent quantities are on a weight basis unless otherwise specified. The operations described below were performed at normal temperature under normal atmospheric pressure unless otherwise specified.

In Examples and Comparative Examples, the glass transition temperature and the gel content of the particulate polymer (C), rated capacity of the negative electrode, initial efficiency, initial efficiency, cycle property, and powder falling rates were evaluated by using the corresponding methods described below.

<Glass Transition Temperature of Particulate Polymer (C)>

The aqueous dispersion containing the particulate polymer (C) was dried at a humidity of 50% and at a temperature of 23° C. to not more than 26° C. for three days, and a film having a thickness of 1±0.3 mm was obtained.

The film was dried in a vacuum dryer at 60° C. for 10 hours.

The dried film was used as a sample, and the glass transition temperature (° C.) of the sample was measured in accordance with JIS K 7121 in a measurement temperature range of −100 to 180° C. and at the rate of heating of 5° C. per minute by using DSC 6220 SII (differential scanning calorimetry manufactured by Nanotechnology Inc.).

<Gel Content of Particulate Polymer (C)>

The aqueous dispersion containing the particulate polymer (C) was prepared. This aqueous dispersion was dried at a humidity of 50% and at a temperature of 23 to 25° C. to form a film having a thickness of 1±0.3 mm. This film was dried in a vacuum dryer at 60° C. for 10 hours. The film was cut into a rectangular shape having a side length of 3 to 5 mm, and about 1 g thereof was taken and precisely weighed.

The weight of this cut-out film piece was defined as w0. The film piece was immersed in 50 g of tetrahydrofuran (THF) at a temperature of 25±1° C. for 24 hours. The film piece taken out of THF was then vacuum-dried at 105° C. for three hours and a weight w1 of the insoluble portion was measured.

The gel content (% by weight) was calculated by the following formula:

Gel content (% by weight)=(w1/w0)×100

<Rated Capacity of Negative Electrode>

The known capacity (mAh/g) of the active material used in the negative electrode was evaluated by using the following criteria. When a plurality of active materials were used, an average value weighted on the basis of the weight of each material was obtained and evaluated.

A: Larger than 700 mAh/g

B: Larger than 360 mAh/g, and 700 mAh/g or smaller

C: 360 mAh/g or smaller

<Initial Efficiency>

Lithium ion secondary batteries of a laminated cell type produced in Examples and Comparative Examples were filled with an electrolytic solution, vacuum-sealed, and left at a temperature of 25° C. for five hours. Subsequently, each lithium ion secondary battery was charged by constant current charging at 0.2 C at a temperature of 25° C. to a cell voltage of 3.65 V, to thereby obtain a value of charged amount C1 (mAh) in this charging. The battery was then subjected to aging treatment at a temperature of 60° C. for 12 hours, and was discharged by constant current discharging at 0.2 C at a temperature of 25° C. to a cell voltage of 2.75 V, to thereby obtain a value of discharged amount D1 (mAh) in this discharging.

The battery was then charged by CC-CV charging (CC charging was performed at a constant current of 0.2 C and then CV charging was performed at an upper limit cell voltage of 4.20 V) at a constant current of 0.2 C at a temperature of 25° C., to thereby obtain a value of charged amount C2 (mAh) in this charging. Subsequently, the battery was discharged by CC discharging (to a lower limit voltage of 2.75 V) at a constant current of 0.2 C at a temperature of 25° C., to thereby obtain a value of discharged amount D2 (mAh) in this discharging.

The initial efficiency was defined by (D1+D2)/(C1+C2)×100 (%), and was evaluated in accordance with the following criteria.

A: Initial efficiency of 88% or more

B: Initial efficiency of 85% or more, and less than 88%

C: Initial efficiency of 81% or more, and less than 85%

D: Initial efficiency of less than 81%

<Initial Resistance>

After the measurement of the initial efficiency, the cell used in the measurement was charged by constant current charging at 0.1 C at a temperature of 25° C. to a cell voltage of 3.82 V. The cell was then left for five hours, and a voltage V₀ was measured. Subsequently, the cell was discharged at a constant current of 0.5 C at a temperature of −10° C., and a voltage V₂₀ was measured 20 seconds after the start of the discharging.

The initial resistance was defined by a change in voltage represented by ΔVᵢₙᵢ=V₀−V₂₀ and was evaluated by using the following criteria. Smaller value of this voltage change indicates better initial resistance.

A: ΔVᵢₙᵢ of 0.65 V or lower

B: ΔVᵢₙᵢ of higher than 0.65 V, and 0.70 V or lower

C: ΔVᵢₙᵢ of higher than 0.70 V, and 0.75 V or lower

D: ΔVᵢₙᵢ of higher than 0.75V

<Cycle Property>

After the measurement of the initial resistance, the cell used in the measurement was discharged by constant current discharging at 0.1 C at a temperature of 25° C. to a cell voltage of 2.75 V. Subsequently, the cell was repeatedly charged and discharged for 100 cycles at a charging and discharging rate of 4.2 V and 0.5 C at a temperature of 45° C. The capacity at the first cycle, that is, an initial discharging capacity X1, and a discharging capacity X2 that is the capacity at the 100th cycle were measured. A capacity change rate of each cell represented by ΔC′=(X2/X1)×100 (%) was obtained, and was evaluated by using the following criteria. Larger value of this capacity change rate ΔC indicates better cycle property.

A: ΔC′ of 85% or more

B: ΔC′ of 83% or more, and less than 85%

C: ΔC′ of 80% or more, and less than 83%

D: ΔC′ of less than 80%

<Powder Falling Test>

Negative electrodes produced in Examples and Comparative Examples were cut into a 10 cm×10 cm square to obtain test pieces. The weight (Y0) of each test piece was measured. Subsequently, five spots of each test piece were punched by a punching machine to form φ16 mm circular holes. The punched circular pieces and the test pieces with circular holes were air-brushed, and the weight (Y1) of these pieces in total was measured. A powder falling rate (a ratio of the weight after the punching relative to the weight before the punching) was obtained by the following formula. Higher value indicates fewer cracking and separation on the negative electrode.

Powder falling rate=(Y1/Y0)×100(%)

A: 99.98% or more

B: 99.97% or more, and less than 99.98%

C: 99.96% or more, and less than 99.97%

D: Less than 99.96%

### Production Example 1

### Preparation of Particulate Polymer (C1)

In a 5 MPa pressure-resistant container equipped with a stirrer, 65 parts of styrene as an aromatic vinyl monomer, 35 parts of 1,3-butadiene as an aliphatic conjugated diene monomer, 2 parts of itaconic acid as an ethylenically unsaturated carboxylic acid monomer, 1 part of 2-hydroxyethyl acrylate as a hydroxy group containing monomer, 0.3 part of t-dodecyl mercaptan as a molecular weight modifier, 5 parts of sodium dodecylbenzenesulfonate as an emulsifier, 150 parts of ion-exchanged water as a solvent, and 1 part of potassium persulfate as a polymerization initiator were placed and sufficiently stirred. Then, the mixture was warmed to 55° C. to initiate polymerization.

When the monomer consumption reached 95.0%, the mixture was cooled to terminate the reaction. To the aqueous dispersion containing a polymer thus obtained, a 5% aqueous sodium hydroxide solution was added to adjust pH to 8. Subsequently, unreacted monomers were removed by distillation under heating and reduced pressure. The mixture was cooled to 30° C. or lower to obtain an aqueous dispersion of the particulate polymer (C1). With the obtained aqueous dispersion of the particulate polymer (C1), the gel content and the glass transition temperature of the particulate polymer (C1) were measured by the aforementioned methods. The results of the measurement were the gel content of 92% and the glass transition temperature (Tg) of 10° C.

### Production Example 2

### Preparation of Particulate Polymer (C2)

In a 5 MPa pressure-resistant container equipped with a stirrer, 82 parts of butyl acrylate, 2 parts of acrylonitrile, 2 parts of methacrylic acid, 1 part of N-methylol acrylamide, 1 part of allyl glycidyl ether, 4 parts of sodium lauryl sulfate as an emulsifier, 150 parts of ion-exchanged water as a solvent, and 0.5 part of ammonium persulfate as a polymerization initiator were placed and sufficiently stirred. Then, the mixture was warmed to 80° C. to initiate polymerization.

When the polymerization conversion rate reached 96%, the mixture was cooled to terminate the reaction. A mixture containing an acrylic polymer was thus obtained. To the mixture, a 5% aqueous sodium hydroxide solution was added to adjust pH to 7, and a latex of the particulate polymer (C2) was obtained. With the obtained latex of the particulate polymer (C2) as the aqueous dispersion, the gel content and the glass transition temperature of the particulate polymer (C2) were measured by the aforementioned methods. The results of the measurement were the gel content of 90%, and the glass transition temperature (Tg) of −50° C.

### Example 1

### 1-1. Preparation of Slurry Composition for Secondary Battery

In a planetary mixer, 90 parts of artificial graphite (capacity: 360 mAh/g, BET specific surface area: 3.6 m²/g) as a carbon active material, 10 parts of a silicon-containing alloy (manufactured by 3M Company, 1200 mAh/g) as a non-carbon negative electrode active material, 4 parts of carboxymethyl cellulose (product name: “MAC200HC” manufactured by Nippon Paper Chemicals Co., Ltd., etherification degree: 0.8, viscosity of 1% solution: 1800 mPa·s) as a water-soluble polymer, and 69 parts of ion-exchanged water were placed, and mixed in the planetary mixer at 40 rpm for 60 minutes to obtain a paste. The solid content concentration of the paste was 60%. To the obtained paste, 0.20 part in terms of solid content of the aqueous dispersion of the particulate polymer (C1) obtained in Production Example 1 was added. Ion-exchanged water was then added and mixed with the paste to adjust the viscosity of the slurry to 2000 to 6000 mPa·s at a temperature of 25±1° C. on the basis of the measurement by a B-type viscometer. A slurry composition for (a negative electrode of) a secondary battery including the active material (A) that contains a non-graphite active material, the water-soluble polymer (B), the particulate polymer (C), and water was thus prepared.

### 1-2. Production of Negative Electrode

The slurry composition for a secondary battery obtained in step (1-1) was applied onto a 15 μm-thick copper foil (current collector) by a comma coater to adjust the negative electrode capacity per unit surface area to 40.2±0.3 mAh/cm². The copper foil coated with the slurry composition for a secondary battery was conveyed through a 60° C. oven for two minutes, and then conveyed through a 110° C. oven for two minutes at a velocity of 0.3 meter per minute to dry the slurry composition on the copper foil. A negative electrode raw material was thus obtained.

The obtained negative electrode raw material was pressed by roll press to adjust the mixture layer density to 1.63 to 1.67 g/cm³, and was placed in a vacuum environment at a temperature of 120° C. for 10 hours to remove water. A negative electrode including a current collector and a negative electrode material layer formed thereon was thus obtained.

Powder falling test was conducted on the obtained negative electrode. The results are listed in Table 1.

### 1-3. Production of Positive Electrode

In a planetary mixer, 100 parts of LiCoO₂ as a positive electrode active material, 2 parts of acetylene black (“HS-100” manufactured by Denki Kagaku Kogyo Kabushiki Kaisha) as a conductive additive, and 2 parts of polyvinylidene fluoride (PVDF) (“KF-1100” manufactured by Kureha Corporation) were placed, and a certain amount of 2-methylpyrrolidone was added thereto and mixed to adjust the solid content concentration to 67%. A slurry composition for a positive electrode was thus prepared.

The obtained slurry composition for a positive electrode was applied onto a 20 μm-thick aluminum foil by a comma coater to adjust the positive electrode capacity per unit surface area to 38.3±0.3 mAh/cm². The aluminum foil coated with the slurry composition was conveyed through a 60° C. oven for two minutes, and then conveyed through a 120° C. oven for two minutes at a velocity of 0.5 meter per minute to dry the slurry composition. A positive electrode raw material was thus obtained.

The obtained positive electrode raw material was pressed by roll press to adjust the after-press density to 3.40 to 3.50 g/cm³, and was placed in a vacuum environment at a temperature of 120° C. for three hours to remove water. A positive electrode including a current collector and a positive electrode material layer formed thereon was thus obtained.

### 1-4. Production of Lithium Ion Secondary Battery

A single-layer polypropylene separator (width: 65 mm, length: 500 mm, thickness: 25 μm, produced by dry method, porosity: 55%) was prepared and cut into a square of 5×5 cm² to obtain a square separator.

The negative electrode produced in step (1-2) was cut into a rectangular shape of 4.0×3.0 cm to obtain a rectangular negative electrode.

The positive electrode produced in step (1-3) was cut into a rectangular shape of 3.8×2.8 cm to obtain a rectangular positive electrode.

As the electrolytic solution, a mixed solvent of ethylene carbonate (EC)/ethyl methyl carbonate (EMC)=3/7 (volume ratio) (containing 2 parts by volume of vinylene carbonate as an additive and 1.0 M of LiPF₆) was prepared.

As the package of the battery, an aluminum package was prepared.

The rectangular positive electrode was placed inside the aluminum package such that a surface of the positive electrode at the current collector side was in contact with the aluminum package. The square separator was placed on a surface of the rectangular positive electrode at the positive electrode material layer side. The rectangular negative electrode was placed on the separator such that a surface of the negative electrode at the negative electrode material layer side was in contact with the separator. The aluminum package was filled with the electrolytic solution. The aluminum package was closed and heat-sealed at a temperature of 150° C. A lithium ion secondary battery of a laminated cell type was thus produced.

The initial efficiency, initial resistance, and cycle property of the lithium ion secondary battery thus produced were measured and evaluated. The results are listed in Table 1.

### Example 2

A slurry composition for a negative electrode of a secondary battery, a negative electrode, a positive electrode, and a lithium ion secondary battery were produced and evaluated in the same manner as in Example 1 except that the amount of the carbon active material was changed to 85 parts and the amount of the non-carbon negative electrode active material was changed to 15 parts in the preparation of the slurry composition for a secondary battery in step (1-1). The results are listed in Table 1.

### Example 3

A slurry composition for a negative electrode of a secondary battery, a negative electrode, a positive electrode, and a lithium ion secondary battery were produced and evaluated in the same manner as in Example 1 except that the amount of the carbon active material was changed to 80 parts and the amount of the non-carbon negative electrode active material was changed to 20 parts in the preparation of the slurry composition for a secondary battery in step (1-1). The results are listed in Table 1.

### Example 4

A slurry composition for a negative electrode of a secondary battery, a negative electrode, a positive electrode, and a lithium ion secondary battery were produced and evaluated in the same manner as in Example 1 except that the amount of the carbon active material was changed to 70 parts and the amount of the non-carbon negative electrode active material was changed to 30 parts in the preparation of the slurry composition for a secondary battery in step (1-1). The results are listed in Table 1.

### Example 5

A slurry composition for a negative electrode of a secondary battery, a negative electrode, a positive electrode, and a lithium ion secondary battery were produced and evaluated in the same manner as in Example 1 except that the amount of the carbon active material was changed to 60 parts and the amount of the non-carbon negative electrode active material was changed to 40 parts in the preparation of the slurry composition for a secondary battery in step (1-1). The results are listed in Table 1.

### Example 6

A slurry composition for a negative electrode of a secondary battery, a negative electrode, a positive electrode, and a lithium ion secondary battery were produced and evaluated in the same manner as in Example 1 except that the amount of the carbon active material was changed to 50 parts and the amount of the non-carbon negative electrode active material was changed to 50 parts in the preparation of the slurry composition for a secondary battery in step (1-1). The results are listed in Table 1.

### Example 7

A slurry composition for a negative electrode of a secondary battery, a negative electrode, a positive electrode, and a lithium ion secondary battery were produced and evaluated in the same manner as in Example 1 except that the amount of the carbon active material was changed to 20 parts and the amount of the non-carbon negative electrode active material was changed to 80 parts in the preparation of the slurry composition for a secondary battery in step (1-1). The results are listed in Table 1.

### Example 8

A slurry composition for a negative electrode of a secondary battery, a negative electrode, a positive electrode, and a lithium ion secondary battery were produced and evaluated in the same manner as in Example 1 except that the carbon active material was not used and the amount of the non-carbon negative electrode active material was changed to 100 parts in the preparation of the slurry composition for a secondary battery in step (1-1). The results are listed in Table 1.

### Examples 9 to 12

A slurry composition for a negative electrode of a secondary battery, a negative electrode, a positive electrode, and a lithium ion secondary battery were produced and evaluated in the same manner as in Example 1 except that the amount of carboxymethyl cellulose was changed to the values listed in Table 1 in the preparation of the slurry composition for a secondary battery in step (1-1). The results are listed in Table 1.

### Example 13 to 17

A slurry composition for a negative electrode of a secondary battery, a negative electrode, a positive electrode, and a lithium ion secondary battery were produced and evaluated in the same manner as in Example 1 except that the amount of the aqueous dispersion of the particulate polymer (C1) in terms of solid content was changed to 0.01 part (Example 13), 0.05 part (Example 14), 0.1 part (Example 15), 0.3 part (Example 16), or 0.4 part (Example 17) in the preparation of the slurry composition for a secondary battery in step (1-1). The results are listed in Table 1.

### Example 18

A slurry composition for a negative electrode of a secondary battery, a negative electrode, a positive electrode, and a lithium ion secondary battery were produced and evaluated in the same manner as in Example 1 except that 0.2 part of the latex of the particulate polymer (C2) in terms of solid content produced in Production Example 2 was used in place of the aqueous dispersion of the particulate polymer (C1) in the preparation of the slurry composition for a secondary battery in step (1-1). The results are listed in Table 1.

### Example 19

### 19-1. Preparation of Water-Soluble Polymer

pH of a 1% solution of a polycarboxylic acid (manufactured by Sigma-Aldrich Corporation, molecular weight: 1250 thousand) was adjusted to 8 with NaOH (special grade chemical of Wako Pure Chemical Industries, Ltd.), to obtain a polycarboxylic acid sodium salt (PAA-Na) solution.

### 19-2. Preparation of Slurry Composition for Secondary Battery

In a planetary mixer, 90 parts of artificial graphite (capacity: 360 mAh/g, BET specific surface area: 3.6 m²/g) as a carbon active material, 10 parts of a silicon-containing alloy (manufactured by 3M Company, 1200 mAh/g) as a non-carbon negative electrode active material, 3.0 parts of carboxymethyl cellulose (product name: “MAC200HC” manufactured by Nippon Paper Chemicals Co., Ltd., etherification degree: 0.8, viscosity of 1% solution: 1800 mPa·s) as a water-soluble polymer, and 69 parts of ion-exchanged water were placed, and mixed in the planetary mixer at 40 rpm for 60 minutes to obtain a paste. To the obtained paste, the polycarboxylic acid sodium salt (PAA-Na) solution produced in (19-1) above was added in an amount of 1 part in terms of solid content, and the paste and the solution were mixed in the planetary mixer at 40 rpm for 30 minutes to obtain a paste containing carboxymethyl cellulose and PAA-Na. The ratio of the carboxymethyl cellulose to PAA-Na was 75/25 by weight. To the obtained paste, 0.20 part in terms of solid content of the aqueous dispersion of the particulate polymer (C1) obtained in Production Example 1 was added. Ion-exchanged water was then added and mixed with the paste to adjust the viscosity of the slurry to 2000 to 6000 mPa·s at a temperature of 25±1° C. on the basis of the measurement by a B-type viscometer. A slurry composition for (a negative electrode of) a secondary battery including the active material (A) that contains a non-graphite active material, the water-soluble polymer (B), the particulate polymer (C), and water was thus prepared.

### 19-3. Production of Lithium Ion Secondary Battery and Other Components

A negative electrode, a positive electrode, and a lithium ion secondary battery were produced and evaluated in the same manner as in steps (1-2) to (1-4) in Example 1 except that, in the production of the negative electrode in step (1-2), the slurry composition for a secondary battery obtained in step (19-2) was used in place of the slurry composition for a secondary battery obtained in step (1-1). The results are listed in Table 1.

### Example 20

A slurry composition for a negative electrode of a secondary battery, a negative electrode, a positive electrode, and a lithium ion secondary battery were produced and evaluated in the same manner as in Example 19 except that the ratio of carboxymethyl cellulose to PAA-Na was changed to 50:50 in the preparation of the slurry composition for a secondary battery in step (19-2). The results are listed in Table 1.

### Example 21

### 21-1. Preparation of Water-Soluble Polymer

pH of a 1% solution of a polycarboxylic acid (manufactured by Sigma-Aldrich Corporation, molecular weight: 1250 thousand) was adjusted to 8 with LiOH (special grade chemical of Wako Pure Chemical Industries, Ltd.), to obtain a polycarboxylic acid lithium salt (PAA-Li) solution.

### 21-2. Production of Lithium Ion Secondary Battery and Other Components

A slurry composition for a negative electrode of a secondary battery, a negative electrode, a positive electrode, and a lithium ion secondary battery were produced and evaluated in the same manner as in Example 19 except that, in the preparation of the slurry composition for a secondary battery in step (19-2), the PAA-Li solution obtained at (21-1) above was used in place of the PAA-Na solution. The results are listed in Table 1.

### Example 22

A slurry composition for a negative electrode of a secondary battery, a negative electrode, a positive electrode, and a lithium ion secondary battery were produced and evaluated in the same manner as in Example 21 except that the ratio of carboxymethyl cellulose to PAA-Li was changed to 50:50 in the preparation of the slurry composition for a secondary battery in step (21-2). The results are listed in Table 1.

### Example 23

### 23-1. Preparation of Slurry Composition for Secondary Battery

In a planetary mixer, 90 parts of artificial graphite (capacity: 360 mAh/g) as a carbon active material, 10 parts of a silicon-containing alloy (manufactured by 3M Company, 1200 mAh/g) as a non-carbon negative electrode active material, and 4 parts in terms of solid content of carboxymethyl cellulose (product name “MAC200HC” manufactured by Nippon Paper Chemicals Co., Ltd., etherification degree: 0.8, viscosity of 1% solution: 1900 mPa·s) as a water-soluble polymer were placed, and mixed in the planetary mixer at 40 rpm for 60 minutes to obtain a paste. To the obtained paste, cellulose nanofibers (product name “CELISH (registered trademark) KY-100G” manufactured by Daicel Corporation, fiber diameter: 0.07 μm) were added in an amount of 0.001 part in terms of solid content (the amount of 0.001 part in terms of solid content corresponds to an amount of 0.5 part of cellulose nanofibers with respect to 100 parts of the particulate polymer (C)), and mixed at 40 rpm for 30 minutes. Subsequently, the aqueous dispersion of the particulate polymer (C1) obtained in Production Example 1 was added to the paste in an amount of 0.20 part in terms of solid content, and ion-exchanged water was added to the paste and mixed to adjust the entire solid content concentration to 50%. A slurry composition for (a negative electrode of) a secondary battery including the active material (A) that contains a non-graphite active material, the water-soluble polymer (B), the particulate polymer (C), cellulose nanofibers, and water was thus prepared.

### 23-2. Production of Lithium Ion Secondary Battery and Other Components

A negative electrode, a positive electrode, and a lithium ion secondary battery were produced and evaluated in the same manner as in steps (1-2) to (1-4) in Example 1 except that, in the production of the negative electrode in step (1-2), the slurry composition for a secondary battery obtained in step (23-1) was used in place of the slurry composition for a secondary battery obtained in step (1-1). The results are listed in Table 1.

### Examples 24 and 25

A slurry composition for a negative electrode of a secondary battery, a negative electrode, a positive electrode, and a lithium ion secondary battery were produced and evaluated in the same manner as in Example 23 except that the amount of cellulose nanofibers was changed to 2 parts (Example 24) or 5 parts (Example 25) in terms of solid content with respect to 100 parts of the particulate polymer (C). The results are listed in Table 1.

### Example 26

A slurry composition for a negative electrode of a secondary battery, a negative electrode, a positive electrode, and a lithium ion secondary battery were produced and evaluated in the same manner as in Example 1 except that SiOₓ (manufactured by Shin-Etsu Chemical Co., Ltd., 2600 mAh/g) was used as the non-carbon negative electrode active material in place of the silicon-containing alloy in the preparation of the slurry composition for a secondary battery in step (1-1). The results are listed in Table 1.

### Example 27

A slurry composition for a negative electrode of a secondary battery, a negative electrode, a positive electrode, and a lithium ion secondary battery were produced and evaluated in the same manner as in Example 1 except that the amount of the carbon active material was changed to 80 parts, and SiOₓ (manufactured by Shin-Etsu Chemical Co., Ltd., 2600 mAh/g) was used as the non-carbon negative electrode active material in place of the silicon-containing alloy and the amount thereof was changed to 30 parts in the preparation of the slurry composition for a secondary battery in step (1-1). The results are listed in Table 1.

### Example 28

A slurry composition for a negative electrode of a secondary battery, a negative electrode, a positive electrode, and a lithium ion secondary battery were produced and evaluated in the same manner as in Example 1 except that the amount of the carbon active material was changed to 50 parts, and SiOₓ (manufactured by Shin-Etsu Chemical Co., Ltd., 2600 mAh/g) was used as the non-carbon negative electrode active material in place of the silicon-containing alloy and the amount thereof was changed to 50 parts in the preparation of the slurry composition for a secondary battery in step (1-1). The results are listed in Table 1.

### Comparative Example 1

A slurry composition for a negative electrode of a secondary battery, a negative electrode, a positive electrode, and a lithium ion secondary battery were produced and evaluated in the same manner as in Example 1 except that the amount of the carbon active material was changed to 100 parts, and the non-carbon negative electrode active material was not used in the preparation of the slurry composition for a secondary battery in step (1-1). The results are listed in Table 1.

### Comparative Example 2

A slurry composition for a negative electrode of a secondary battery, a negative electrode, a positive electrode, and a lithium ion secondary battery were produced and evaluated in the same manner as in Example 1 except that the amount of the carbon active material was changed to 95 parts, and the amount of the non-carbon negative electrode active material was changed to 5 parts in the preparation of the slurry composition for a secondary battery in step (1-1). The results are listed in Table 1.

### Comparative Examples 3 and 4

A slurry composition for a negative electrode of a secondary battery, a negative electrode, a positive electrode, and a lithium ion secondary battery were produced and evaluated in the same manner as in Example 1 except that the amount of carboxymethyl cellulose was changed to 0.4 part in Comparative Example 3, or 12 parts in Comparative Example 4 in terms of solid content in the preparation of the slurry composition for a secondary battery in step (1-1). The results are listed in Table 1.

### Comparative Example 5

A slurry composition for a negative electrode of a secondary battery, a negative electrode, a positive electrode, and a lithium ion secondary battery were produced and evaluated in the same manner as in Example 1 except that the aqueous dispersion of the particulate polymer (C1) was not added in the preparation of the slurry composition for a secondary battery in step (1-1). The results are listed in Table 1.

### Comparative Example 6

A slurry composition for a negative electrode of a secondary battery, a negative electrode, a positive electrode, and a lithium ion secondary battery were produced and evaluated in the same manner as in Example 1 except that the amount of the aqueous dispersion of the particulate polymer (C1) was changed to 0.6 part in terms of solid content in the preparation of the slurry composition for a secondary battery in step (1-1). The results are listed in Table 1.

TABLE 1

| | (A) non- | (A) non- | | | | | | Negative | | | | |
|---|---|---|---|---|---|---|---|---|---|---|---|---|
| | carbon | carbon | (B) | | (C) | (C) | CNF | electrode rated | Initial | Initial | Cycle | Powder |
| | amount | type | amount | (B) type | amount | type | amount | capacity | efficiency | resistance | property | falling |
| Ex. 1 | 10 | Si alloy | 4 | CMC | 0.2 | SBR | — | B | A | A | A | A |
| Ex. 2 | 15 | Si alloy | 4 | CMC | 0.2 | SBR | — | B | A | A | A | A |
| Ex. 3 | 20 | Si alloy | 4 | CMC | 0.2 | SBR | — | B | A | A | A | A |
| Ex. 4 | 30 | Si alloy | 4 | CMC | 0.2 | SBR | — | B | A | A | A | A |
| Ex. 5 | 40 | Si alloy | 4 | CMC | 0.2 | SBR | — | B | B | B | B | A |
| Ex. 6 | 50 | Si alloy | 4 | CMC | 0.2 | SBR | — | A | B | B | B | A |
| Ex. 7 | 80 | Si alloy | 4 | CMC | 0.2 | SBR | — | A | C | C | C | A |
| Ex. 8 | 100 | Si alloy | 4 | CMC | 0.2 | SBR | — | A | C | C | C | A |
| Ex. 9 | 10 | Si alloy | 0.5 | CMC | 0.2 | SBR | — | B | C | B | C | A |
| Ex. 10 | 10 | Si alloy | 1 | CMC | 0.2 | SBR | — | B | A | A | B | A |
| Ex. 11 | 10 | Si alloy | 3 | CMC | 0.2 | SBR | — | B | A | A | A | A |
| Ex. 12 | 10 | Si alloy | 8 | CMC | 0.2 | SBR | — | B | B | C | A | A |
| Ex. 13 | 10 | Si alloy | 4 | CMC | 0.01 | SBR | — | B | B | B | B | A |
| Ex. 14 | 10 | Si alloy | 4 | CMC | 0.05 | SBR | — | B | B | B | B | A |
| Ex. 15 | 10 | Si alloy | 4 | CMC | 0.1 | SBR | — | B | A | A | A | A |
| Ex. 16 | 10 | Si alloy | 4 | CMC | 0.3 | SBR | — | B | B | B | B | A |
| Ex. 17 | 10 | Si alloy | 4 | CMC | 0.4 | SBR | — | B | B | B | B | A |
| Ex. 18 | 10 | Si alloy | 4 | CMC | 0.2 | ACL | — | B | B | A | C | A |
| Ex. 19 | 10 | Si alloy | 4 | CMC/PAANa = | 0.2 | SBR | — | B | B | A | A | A |
| | | | | 75%/25% | | | | | | | | |
| Ex. 20 | 10 | Si alloy | 4 | CMC/PAANa = | 0.2 | SBR | — | B | B | A | A | A |
| | | | | 50%/50% | | | | | | | | |
| Ex. 21 | 10 | Si alloy | 4 | CMC/PAALi = | 0.2 | SBR | — | B | A | A | A | A |
| | | | | 75%/25% | | | | | | | | |
| Ex. 22 | 10 | Si alloy | 4 | CMC/PAALi = | 0.2 | SBR | — | B | A | A | A | A |
| | | | | 50%/50% | | | | | | | | |
| Ex. 23 | 10 | Si alloy | 4 | CMC | 0.2 | SBR | 0.5 | B | B | B | B | A |
| Ex. 24 | 10 | Si alloy | 4 | CMC | 0.2 | SBR | 2 | B | B | B | B | A |
| Ex. 25 | 10 | Si alloy | 4 | CMC | 0.2 | SBR | 5 | B | A | B | B | A |
| Ex. 26 | 10 | SiOx | 4 | CMC | 0.2 | SBR | — | B | B | B | B | A |
| Ex. 27 | 20 | SiOx | 4 | CMC | 0.2 | SBR | — | A | B | B | B | A |
| Ex. 28 | 50 | SiOx | 4 | CMC | 0.2 | SBR | — | A | C | A | B | A |
| Comp. | 0 | — | 4 | CMC | 0.2 | SBR | — | C | D | D | A | A |
| Ex. 1 | | | | | | | | | | | | |
| Comp. | 5 | Si alloy | 4 | CMC | 0.2 | SBR | — | B | C | C | D | A |
| Ex. 2 | | | | | | | | | | | | |
| Comp. | 10 | Si alloy | 0.4 | CMC | 0.2 | SBR | — | B | C | C | D | A |
| Ex. 3 | | | | | | | | | | | | |
| Comp. | 10 | Si alloy | 12 | CMC | 0.2 | SBR | — | B | D | D | D | A |
| Ex. 4 | | | | | | | | | | | | |
| Comp. | 10 | Si alloy | 4 | — | 0 | — | — | B | C | D | D | D |
| Ex. 5 | | | | | | | | | | | | |
| Comp. | 10 | Si alloy | 4 | CMC | 0.6 | SBR | — | B | C | C | D | A |
| Ex. 6 | | | | | | | | | | | | |

As shown by the results in Table 1, the negative electrodes produced in Examples 1 to 28 including a the specific active material (A), water-soluble polymer (B), and particulate polymer (C) in the specific ratio achieved good properties in well-balanced manner, such as capability of successfully providing the secondary battery with a large capacity, high initial efficiency, low initial resistance, and excellent cycle property, as well as reduction in the occurrence of powder falling.

1. A slurry composition for a negative electrode of a lithium ion secondary battery, the slurry composition comprising:
100 parts by weight of an active material (A) containing 8% by weight or higher of a non-carbon negative electrode active material;
0.5 to 10 parts by weight of a water-soluble polymer (B) containing a carboxy group;
0.01 to 0.5 parts by weight of a particulate polymer (C); and
water.

2. The slurry composition according to claim 1, wherein the non-carbon negative electrode active material contained in the active material (A) is a silicon active material.

3. The slurry composition according to claim 1, wherein the water-soluble polymer (B) is selected from the group consisting of carboxymethyl cellulose, a polycarboxylic acid, salts thereof, and mixtures thereof.

4. The slurry composition according to claim 1, wherein the particulate polymer (C) includes an aliphatic conjugated diene monomer unit and an aromatic vinyl monomer unit.

5. A negative electrode for a lithium ion secondary battery, the negative electrode comprising a negative electrode material layer obtained from the slurry composition according to claim 1.

6. A lithium ion secondary battery, comprising: the negative electrode for a lithium ion secondary battery according to claim 5; a positive electrode; an electrolytic solution; and a separator.
